(19) United States
(12) Patent Application Publication
(10) Pub. No.: US 2015/0186473 A1
(43) Pub. Date: Jul. 2, 2015

(54) SYSTEM AND METHOD FOR USER INTERFACE IN DASHBOARD SOFTWARE

(71) Applicant: GENERAL ELECTRIC COMPANY, SCHENECTADY, NY (US)

(72) Inventors: Li Ye Chen, Shelton, CT (US); Ignatius B. D. Anandappa, Fairfield, CT (US); James Blomberg, Fairfield, CT (US); Katrina Craigwell, New York, NY (US); James Marcum, Fairfield, CT (US)

(73) Assignee: GENERAL ELECTRIC COMPANY, SCHENECTADY, NY (US)

(21) Appl. No.: 14/142,238

(22) Filed: Dec. 27, 2013

(51) Int. Cl. G06F 17/30

(52) U.S. Cl. CPC G06F 17/30554

(57) ABSTRACT

A non-transitory computer-readable medium storing computer executable code that runs a digital dashboard application. The digital dashboard application includes a visualization data structure containing visualizations; a metric data structure containing metrics; and a metric box interface that displays one or more metric boxes. A metric box is configured to display a primary set of metadata associated with a metric in the metric data structure and the primary set of metadata includes one of the visualizations in the visualization data structure. Two or more metric boxes may be combined such that the metrics displayed in the metric boxes serve as inputs in a data manipulation operation. The output of the data manipulation operation is displayed in an additional metric box.

### BACKGROUND

The subject matter disclosed herein relates generally to business data visualization software. Specifically, the embodiments described relate to a user interface structure for business dashboard software.

Many companies use data analysis to evaluate progress towards quantifiable goals and, subsequently, measure company success. Traditionally, relevant data would be stored in a database, and periodically the company would analyze the data and submit the findings in a report. This method could be slow and expensive, especially when considering different facets of the process, such as the numerous types of data that might need to be analyzed, or that some companies may outsource the task to an outside firm.

In recent years, analytics firms have developed business data visualization software specifically for displaying analyzed business data, as well as other types of software intended to automate portions of the data aggregation and analysis process. One particular type of business data visualization software is business dashboard software, which presents analyzed data in a fashion similar to the dashboards used in vehicles. However, current versions of business dashboard software still present a range of issues.

Oftentimes, there is a tradeoff between the various ways a user can view analyzed data and the amount of types of analyzed data the software can support. Further, regardless of how customizable the software is, it may still require a lot of time, effort, and/or computer skills for the user to change the existing set-up.

Additionally, the vast majority of digital dashboards show analyzed data in static positions (although the data may be updated from time to time), with no substantial way to interact with and manipulate the data. For example, if active data manipulation does occur, it is typically from a raw data standpoint, i.e., a user manipulates a spreadsheet or database outside of the software that is then used to generate the analyzed data.

Finally, the business data visualization software may only present analyzed data, but does not necessarily provide a link to making decisions based on that data. For example, a user may be able to see how popular a video series is, but he or she may have to check the software regularly to determine if and when they can expect to meet their target popularity level. Another example is that the user may need to regularly check the software to determine if the popularity level of the video series falls below a certain limit, which would likely trigger a contingency plan such as creating a new promotion.

### BRIEF DESCRIPTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a non-transitory computer-readable medium may store computer executable code relating to a digital dashboard application. The digital dashboard application may include a visualization data structure that stores visualizations and a metric data structure that stores metrics. The digital dashboard application may also include a metric box interface that displays one or more metric boxes. A metric box may be configured to display a primary set of metadata associated with a metric in the metric data structure. The primary set of metadata may include a visualization stored in the visualization data structure. Additionally, if two or more metric boxes are combined, the metrics displayed in the metric boxes may serve as inputs in a data manipulation operation, with the output of the data manipulation operation displayed in an additional metric box.

In a second embodiment, a system may include a memory, a display, a user input device, and a processor configured to control digital dashboard software. The digital dashboard software may include a visualization data structure that stores visualizations and a metric data structure that stores metrics. The digital dashboard software may also include a metric box interface that displays one or more metric boxes. A metric box may display a primary set of metadata associated with a metric in the metric data structure. The primary set of metadata may a visualization in the visualization data structure. Additionally, if two or more metric boxes are combined, the metrics displayed in the metric boxes may serve as inputs in a data manipulation operation, with the output of the data manipulation operation displayed in an additional metric box.

In a third embodiment, a method for displaying and controlling information in a metric box interface includes storing a visualization in a visualization data structure and storing a metric in a metric data structure. The method may also include displaying a metric box that includes a metric stored in the metric data structure using a visualization stored in the visualization data structure. Further, the method may include manipulating data associated with two or more metric boxes in response to user input and organizing metric boxes in response to user input.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram of a computer system, in accordance with an embodiment of the present approach;

FIG. 2 is a screenshot of an interface of a business dashboard software with a metric box interface, in accordance with an embodiment of the present approach;

FIG. 3 is a screenshot of a metric box, in accordance with an embodiment of the present approach;

FIG. 4 is a screenshot of a user interface displayed when creating a metric box, in accordance with an embodiment of the present approach;

FIG. 5 is a screenshot of a graphic icon catalog interface for the metric box of FIG. 3, in accordance with an embodiment of the present approach;

FIG. 6 is a screenshot of a time range selection interface for the metric box of FIG. 3, in accordance with an embodiment of the present approach;

FIG. 7 is a screenshot of a color selection interface for the metric box of FIG. 3, in accordance with an embodiment of the present approach;

FIG. 8 is a screenshot of a text description for the metric box of FIG. 3, in accordance with an embodiment of the present approach;

FIG. 9 is a visualization depicting a metric and an associated goal, in accordance with an embodiment of the present approach;

FIG. 10 is a visualization depicting a metric and an associated goal, in accordance with another embodiment of the present approach;

FIG. 11 is a screenshot of a to-do list interface for the metric box of FIG. 3, in accordance with an embodiment of the present approach;

FIG. 12 is a screenshot of a download interface for the metric box of FIG. 3, in accordance with an embodiment of the present approach;

FIG. 13 is a screenshot of metric boxes of varying sizes, in accordance with an embodiment of the present approach;

FIG. 14 is a block diagram of the process for creating a dynamically computed metric box, in accordance with an embodiment of the present approach;

FIG. 15 is a block diagram of the process for creating a dynamically computed metric box, in accordance with another embodiment of the present approach;

FIG. 16 is a screenshot of a widget, in accordance with an embodiment of the present approach;

FIG. 17 is a screenshot of the process for creating a widget, in accordance with an embodiment of the present approach; and

FIG. 18 is a screenshot of a metric box interface with multiple screens, in accordance with an embodiment of the present approach.

### DETAILED DESCRIPTION

One or more specific embodiments of the present subject matter will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. The term “metric” refers to a specific set of analyzed data, and the term “widget” refers to a collection of related metrics.

Present embodiments relate to systems and methods for business data visualization software. Specifically, the described embodiments relate to business dashboard software used to present disparate types of business metrics. The business dashboard software may include a metric box user interface structure, which may display each metric, and any relevant information, in its own metric box. A user may be able to perform actions to the metric box to customize the metric box. The user may also be able to assign attributes to the metric boxes to link the associated data to future actions performed by the user and to share the associated data with others. The user may also be able to combine metric boxes to perform various mathematical operations on the associated data. The user may be able to organize metric boxes into widgets, and may be able to organize metric boxes and widgets onto one or more screens of the dashboard software.

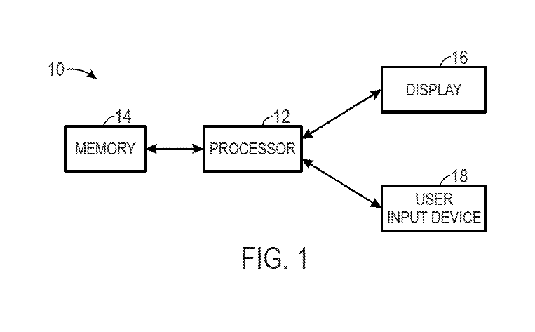

With the foregoing in mind, FIG. 1 illustrates a computer system 10 on which business data visualization software may run. The computer system 10 may include a processor 12 and memory 14. The processor 12 may execute instructions, stored on the memory 14, for running business data visualization software. The processor 12 may include, for example, general-purpose single-or multi-chip microprocessors. In addition, the processor 12 may be any conventional special purpose processor, such as an application-specific processor or circuitry. The memory 14 may be a mass storage device, a FLASH memory device, removable memory, etc. The system 10 may also include a display 16 for a user to view the business data visualization software and a user input device 18 (e.g., a keyboard, mouse, touchscreen, gesture input device, etc.) to allow the user to interact with the business data visualization software.

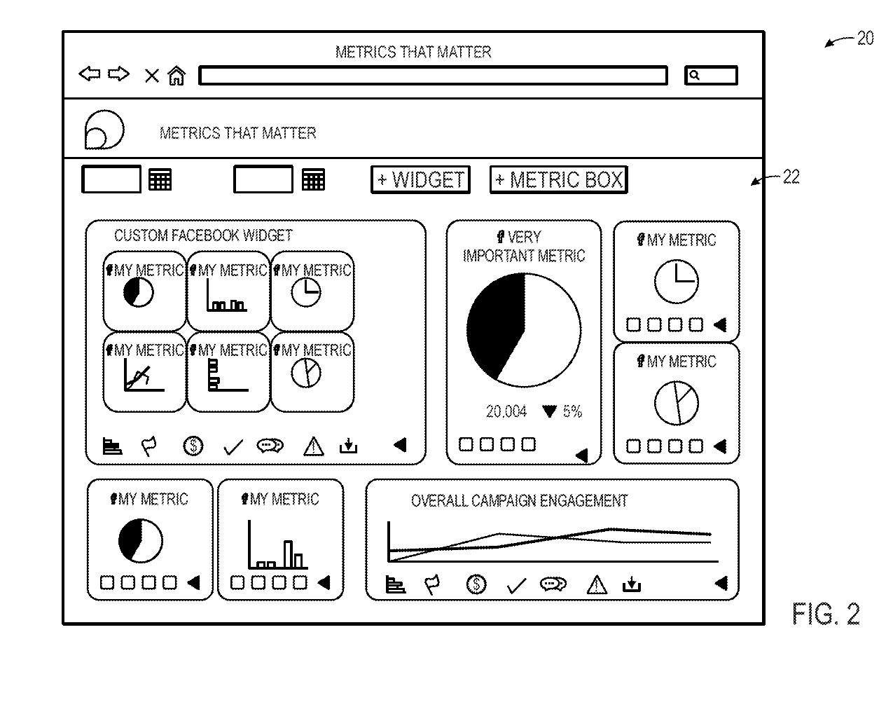

A business dashboard software program 20 is a particular type of business data visualization software characterized by displaying disparate types of metric in a format similar to the dashboards found in vehicles, as illustrated in FIG. 2. The business dashboard software 20 may be used to display many categories of metrics (e.g., human resources, careers, and recruiting insights; global growth and marketing insights; brand monitoring pre- and post-earnings; external issues and threat monitoring).

The business dashboard software 20 may be accessible via a web browser. For example, once a company has purchased the business dashboard software, the company may be provided with a uniform resource locator (URL) to a secure website hosting the business dashboard software 20. The business dashboard software 20 may also be an application that can be installed on a device and run outside of the web browser. In such a case, a company may purchase the business dashboard software 20, and may then be provided with a URL to a secure website from which the company may download the software.

In other embodiments, the business dashboard software 20 may be available both as a website accessible by a web browser as well as a program that may be installed on a device and run outside of a web browser. In such an embodiment, the manner in which the business dashboard software 20 is accessed may depend on the needs and desires of the user as well as the type of device being used to access the software. Additionally, the business dashboard software 20 may include a sync function that, regardless of the device the user is on, saves any changes made by a user to an offsite server.

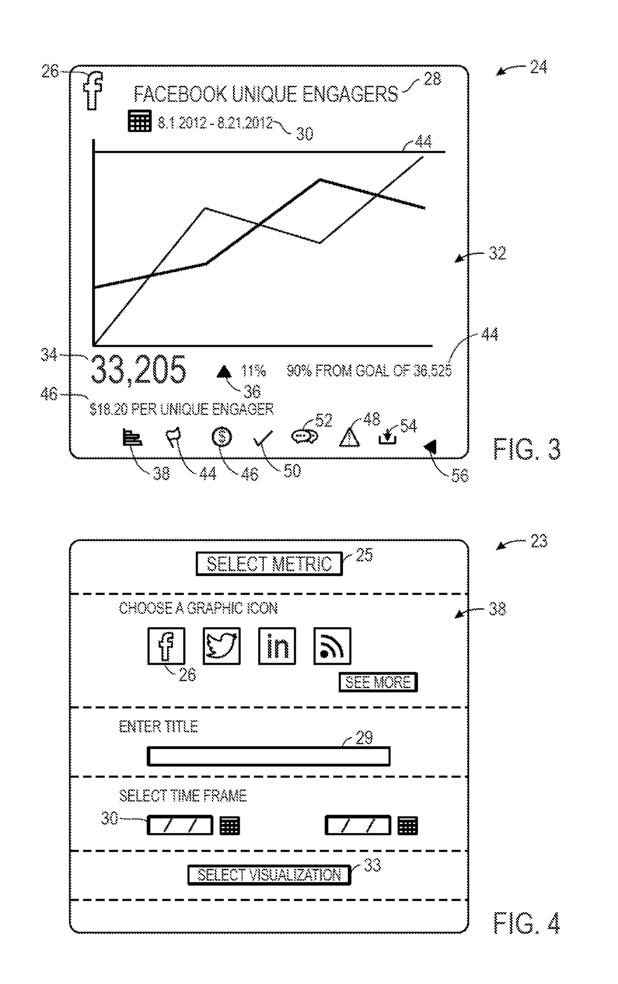

The business dashboard software 20 may include a metric box interface 22 as its user interface structure. In a metric box interface 22, each metric displayed in the dashboard software may be displayed in its own metric box 24, as illustrated in FIG. 3. The metric box 24 may include a primary set of metadata and a secondary set of metadata related to the metric. Further, the metric box 24 may be configured to always display the primary set of metadata, while the display of the secondary set of metadata may depend on other facts (e.g., size of the metric box, amount of secondary metadata available). The metrics and any relevant information, i.e., the primary and secondary sets of metadata, may be stored in a metric data structure on the memory 14.

The primary set of metadata for a metric may include a graphic icon 26, a title 28, a time range value 30, a visualization 32, a current numeric value 34, and a delta numeric value 36. As mentioned above, the metric box 24 may be configured to always display the primary set of metadata. The set of metadata can be added or removed in the future depending on business needs.

FIG. 4 illustrates a user interface 23 that may appear when a user first creates the metric box 24. As shown, the user interface 23 may include a button 25 to select the metric to be displayed in the metric box 24. As will be appreciated, a user interface prompted by selecting the button 25 may vary according to the dashboard software 20. For example, in certain embodiments, selecting the button 25 may elicit a user interface in which the user may select one of many types of metrics available to the dashboard software 20. Alternatively, the user interface prompted by the button 25 may allow the user to specify a mathematical function (e.g., averaging, maximum, etc.) to perform on a metric.

The user may also select the graphic icon 26 and enter the title 28 within the user interface 23. The graphic icon 26 may be any suitable icon that represents the category of the metric, and the title 28 may be any name for the metric displayed. The user may select the graphic icon 26 from a graphic icon catalog 38 and may enter a title 28 via a text input box 29, as illustrated in FIG. 4. Alternatively, when the user first creates the metric box 24, the dashboard software 20 may automatically assign a graphic icon 26 and/or a title 28. The user may also specify a time range 30 via the user interface 23, as illustrated in FIG. 4. The time range 30 indicates the start and end date for the metric displayed in the visualization 32. In certain embodiments, the dashboard software 20 may display an error message if the user attempts to select a time range 30 for which data is unavailable.

Referring again to FIG. 3, the visualization 32 may be a graph or chart that depicts the current quantitative value of the metric. Depending on the type of visualization displayed, the visualization 32 may also indicate the change in quantitative value over the time range 30. The visualization may also display other features related to the metric, such as the current value's distance from a goal, which is described in further detail below. The user interface 23 may include a button 33 to select the visualization 32, as illustrated in FIG. 4. In certain embodiments, selecting the button 33 may prompt a user interface for the user to select a visualization 32 from a visualization catalog, similar to the process of selecting a graphic icon 26. Alternatively, the dashboard software 20 may automatically select a visualization 32 based on the type of metric. All visualizations 32 may be stored in a visualization data structure on the memory 14, separate from any data structures containing information regarding the metrics themselves. Further, the business dashboard software 20 may be configured such that any visualization 32 may be used for any metric box 24. By “separating” the visualizations 32 from the metrics they represent, the dashboard software 20 may allow for more customization in the display of metrics.

Referring again to FIG. 3, the current numeric value 34 may represent the most recent quantitative value of the metric, and the delta numeric value may represent the change in quantitative value of the metric in the time range 30. The current numeric value 34 and the delta numeric value 36 may be automatically generated upon creation of a metric box 24, as well as any time the metric box is refreshed (e.g., new data is added, a new time range is selected, etc.). It should be appreciated that as the current numeric value 34 and the delta numeric value 36 depend on the actual metric, these two components cannot themselves be edited. However, the user may be able to change certain features related to the display of the current numeric value 34 and the delta numeric value 36, as discussed in further detail below.

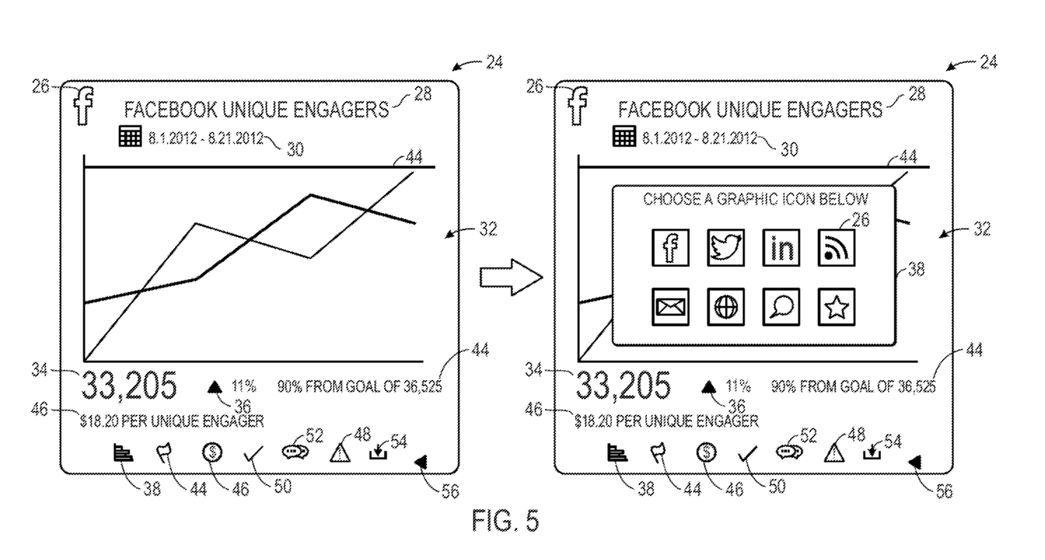

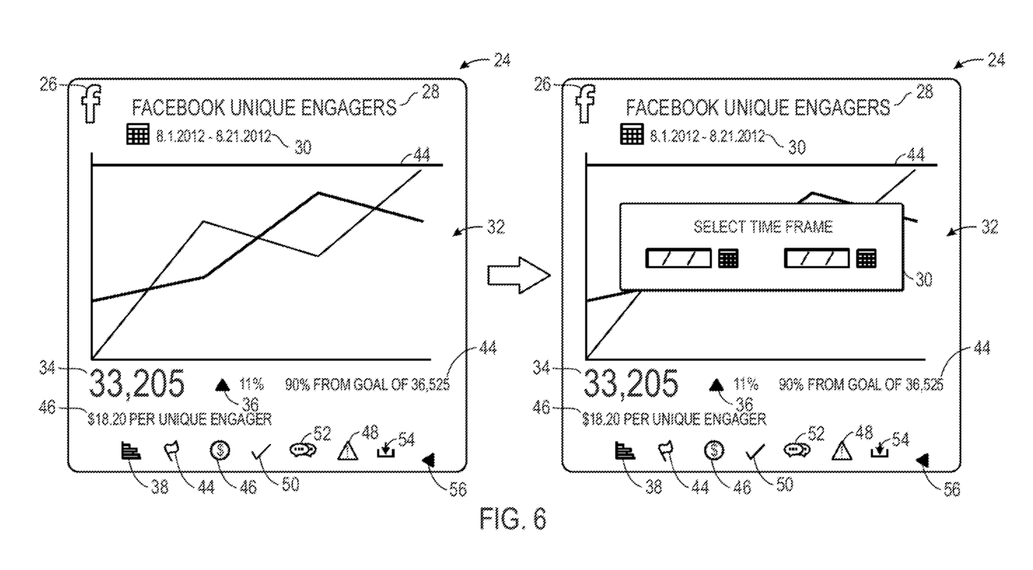

After the initial creation of the metric box 24, the user may be able to edit the graphic icon 26, the title 28, the time range 30, and the visualization 32. To select the particular metadata to edit, the user may interact with the piece of metadata in question (e.g., double clicking with a mouse, a tap and hold on a touchscreen, etc.), as illustrated in FIGS. 5 and 6. Alternatively, the user may be able to select an empty of area of the metric box 24 to bring up a list of options that includes editing one or more components of the metadata. Selecting a particular metadata to edit may prompt the same selection processes employed in creating the metric box. In some embodiments, the user may select a visualization icon 38 to change the visualization 32, as illustrated in FIG. 3. Selecting a new time range 30 may prompt the software 20 to refresh the metric box 24.

The secondary set of metadata for a metric box may include one or more colors 40, a text description 42, goals 44, an overall value 46, alerts 48, and a to-do list 50. As mentioned above, various components of the secondary metadata may not always be displayed in the metric box 24, due to factors such as the size of the metric box and the amount of secondary metadata associated with the metric. Accordingly, goals 44, overall value 46, alerts 48, and to-do list 50 may be accessible via an icon, as illustrated in FIG. 3. Alternatively, when the secondary metadata of the metric box is hidden, the user may be able to view the secondary metadata by selecting the metric box 24 (e.g., double-clicking, double-tapping, etc.).

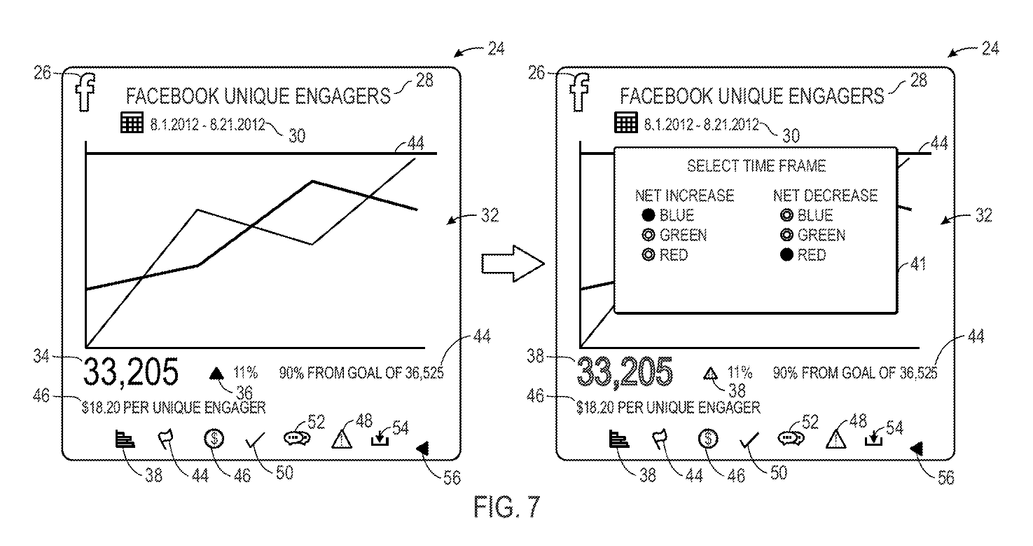

The color 40 may be assigned to a graphic label or numeric value in the metric box 24 to indicate if the change over the time range value 30 is a net increase or a net decrease. For example, a green label may indicate a net increase, while a red label may indicate a net decrease. When creating a metric box, the user may be able to select which colors are associated with a net increase or decrease via the user interface 23. Selecting the graphic label or numeric value in question may also prompt a color interface 41 for the user to select the colors 40, as illustrated in FIG. 7.

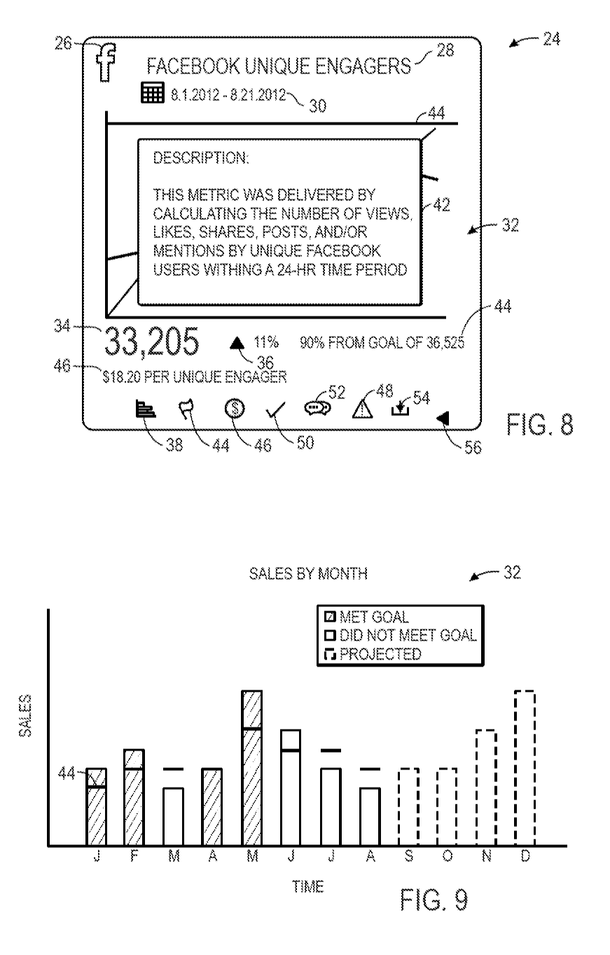

The text description 42 may contain any information describing the metric displayed, including how it is derived. The text description 42 may be automatically generated by the dashboard software 20 when the metric box 24 is created. The user may also be able to edit the text description 42 via a text input box, similar to the title 28. As described above, the text description 42 may or may not be displayed within the metric box 24. If the text description 42 is not displayed in the metric box 24, it may be viewed by hovering over the metric box using a mouse or a hand tracked by a gesture input device, as illustrated in FIG. 8. Alternatively, selecting an empty space (e.g., by right-clicking) within the metric box 24 may prompt a list of options that includes viewing and editing the text description box 42.

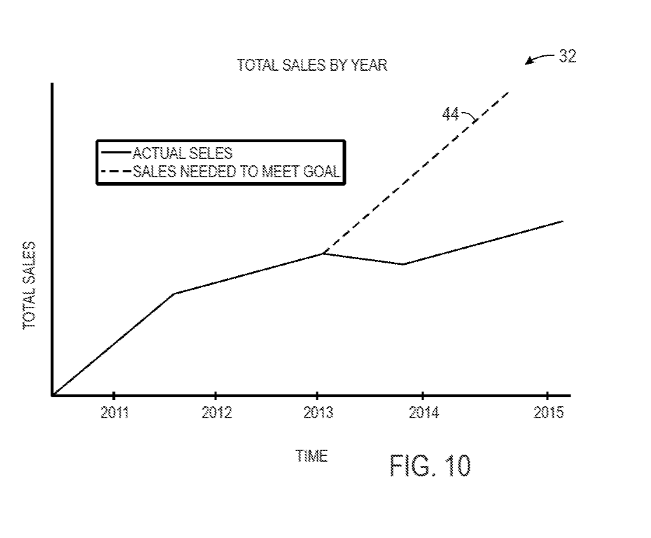

A user may associate one or more goals 44 with a metric. A goal 42 may include information regarding the desired end quantitative value, the desired overall quantitative value over time, and the time range evaluated. The goal 44 may be incorporated in the visualization 32. For example, FIG. 9 depicts a visualization 32 in the form of a bar chart, in which the goal 44 is marked on the bar. FIG. 10 depicts a visualization 32 in the form of a line chart, where a second line marks the projected sales needed to reach the current goal. The goal 44 may also be displayed as text indicating the desired end quantitative value and how close the metric currently is, as illustrated in FIG. 3. Selecting the goal icon described above may prompt an interface for the user to edit the goals 44 associated with the displayed metric.

A user may designate an overall value 46 associated with a displayed metric, as illustrated in FIG. 3. The overall value 46 may be displayed as text within the metric box 24; it may also be accessed via an overall value icon, as described above. Selecting the overall value icon may prompt an interface for the user to edit the overall value 46 associated with the displayed metric.

A user may also set one or more alerts 48 via an alert icon, as illustrated in FIG. 3. The alerts 48 may send a notification to the user when the current or delta numeric values reach a certain threshold. For example, a user may set an alert to be notified when the current numeric value 34 surpasses the monthly goal, or an alert to be notified if the delta numeric value 36 decreases at a rate faster than a pre-defined limit. The notification may be sent through any means used by the dashboard software 20 to communicate with the user outside of the program (e.g., email, short messaging service (SMS), etc.). The notification may also be sent through the dashboard software 20 in an in-program notification feature, such as an audio or visual signal if the user is currently active. Alternatively, the notification may be delivered via a messaging system in the software 20.

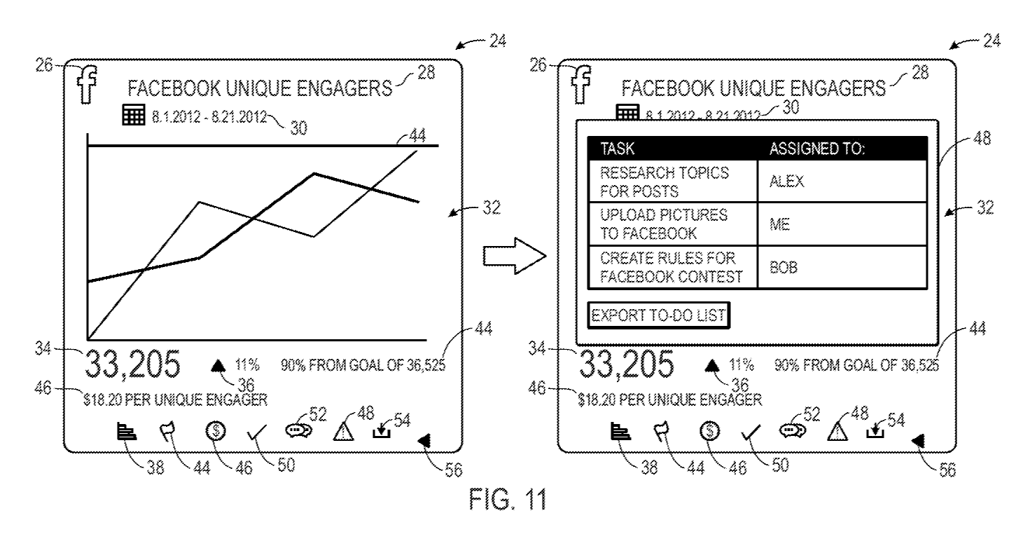

A user may create a to-do list 50 associated with a metric. The to-do list 50 may be accessed by selecting a to-do list icon, as shown in FIG. 11. The user may assign various items on the to-do list 50 to either themselves or other team members. In certain embodiments, the dashboard software 20 may contain contacts for a user, i.e. information regarding other users of the software. If so, then the dashboard software 20 may send a notification to a user's contact when a to-do item is assigned to them. The notification may be sent through any means used by the dashboard software 20 to communicate with the user outside of the program (e.g., email, short messaging service (SMS), etc.). The notification may also be sent through the dashboard software 20 in an in-program notification feature, such as an audio or visual signal if the user is currently active. Alternatively, the notification may be delivered via a messaging system in the software. The dashboard software 20 may also be configured to export the to-do list 50 to a separate computer program.

As illustrated in FIG. 3, there may be other icons displayed with the metric box 24 that allow a user to interact with either the metric displayed or the metric box 24. For example, a user may select a share icon 52 to share a metric box 24 via email or a social network to other users. The user may share a metric box with any person for whom they have an email address or social networking connection. If the person in question does not have access to the business dashboard software 20, then the message may prompt them to purchase the software. Alternatively, the user may share a metric box 24 with one of their contacts within the dashboard software 20, and the software may send a notification to the user's contact as described above. In some embodiments, the dashboard software may automatically add the metric box 24 to the contact's dashboard in addition to sending a notification.

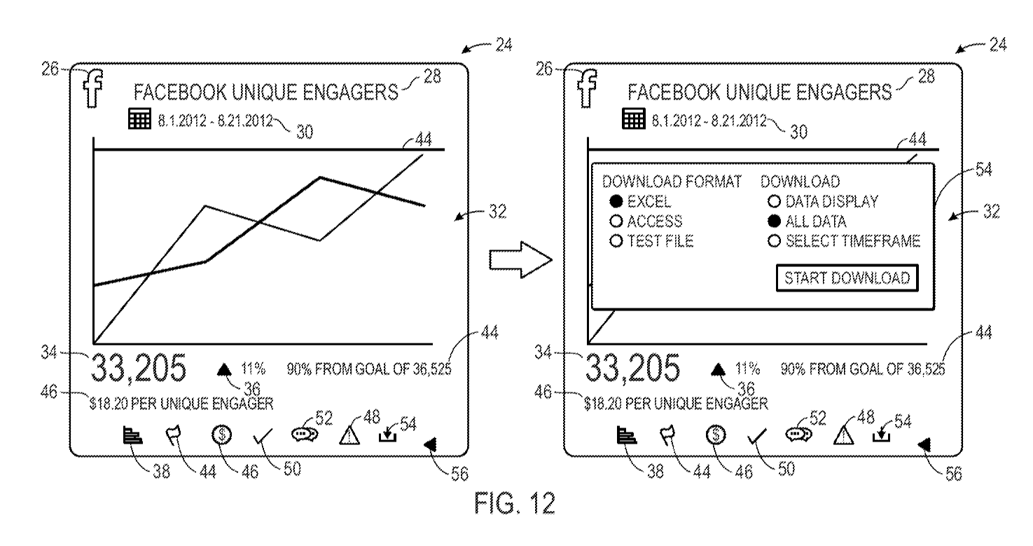

The user may also select a download icon 50 to download archived latest data associated with the metric in a batch format (e.g., an Excel spreadsheet, a comma-separated value file, etc.). As illustrated in FIG. 12, selecting the download icon 54 may prompt an interface for the user to select the desired format for the downloaded data and the time range for the downloaded data. The user may also choose to download only the data currently displayed in the metric box 24 or all of the data accessible by the dashboard software 20. Alternatively, the preferred format for downloaded data may be saved in a user's settings and selecting the download icon 54 may prompt an automatic download of the data currently displayed in the metric box 24 according to the user's settings.

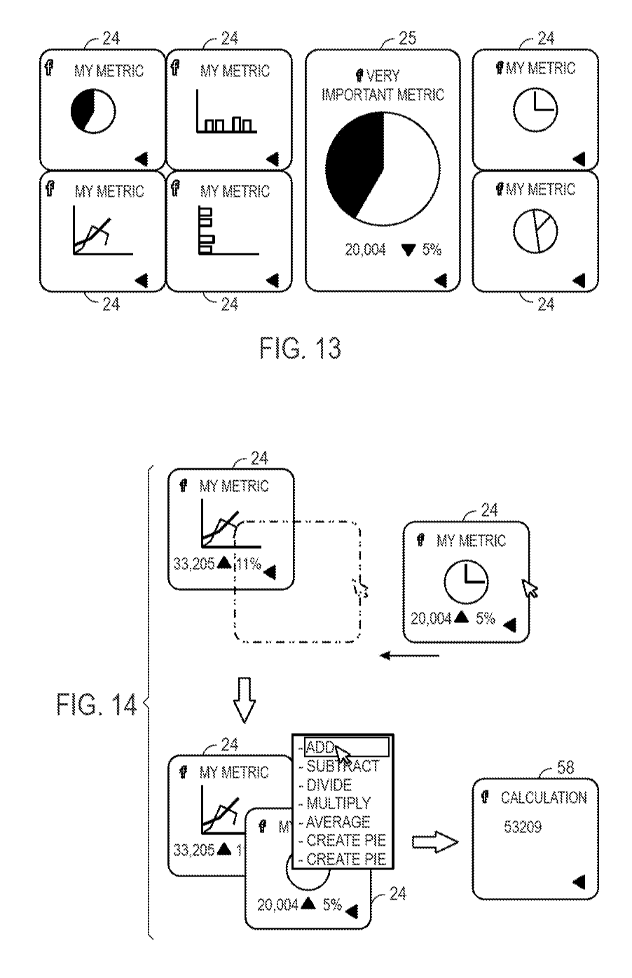

Further, the metric box 24 may include a resize icon 56, as illustrated in FIG. 3. A user may be able to resize the metric box 24 as desired, which may allow the user to draw attention to and organize various metrics according to importance. Further, resizing a metric box 24 may proportionally resize the contents of the metric box. For example, FIG. 13 illustrates “normal-sized” metric boxes 24, and an “oversized” metric box 25 with corresponding resized content. As mentioned above, the dashboard software 20 may be configured to always display the primary set of metadata for a metric box regardless of size, and to display the secondary set of metadata depending on the size of the metric box. As will be appreciated, selecting the resize icon 56 may generate an arrow that allows the user to resize the metric box 24 in a certain direction(s). The arrow may also be generated by hovering over the border of the metric box.

To perform data manipulation within the dashboard software 20, the metric box interface 22 may include a feature of “combining” one or more metric boxes 24 to create a dynamically computed metric box 58. When one or more metric boxes are combined, the data of the associated metrics serve as inputs to a data operation, the results of which are then displayed in a dynamically computed metric box 58. These data operations may include, but are not limited to, addition, subtraction, multiplication, division, averaging, and other mathematical calculations. For example, a user may drag the metric box “Facebook Unique Engagers” over the metric boxes “Twitter Unique Engagers” and “Instagram Unique Engagers” to add the associated values and generate a new metric box 66 displaying the sum. The data operations may also include creating charts containing the input data for side-by-side data comparison. For instance, a user may drag the metric box “Web Visitors” over the metric box “Facebook posts” to generate a new metric box 58 displaying a comparison chart of the values over time, to observe if there is a correlation between web page activity and Facebook activity.

The “combining” action may be dragging a metric box 24 over one or more other metric boxes, which may prompt a list of options. As illustrated in FIG. 14, this list of options may include one or more of the data operations as well as the option to create a widget, which is described in detail below. If one or more metric boxes 24 cannot be combined due to the disparate types of data involved (e.g., attempting to add a percentage value to a whole number value), then an error message may appear. The dynamically computed metric boxes 58 may be the same size as or larger than the metric boxes 24 used as inputs. Additionally, the data operation may be included in the text description 42 of the dynamically computed metric boxes as the information on how the metric is derived.

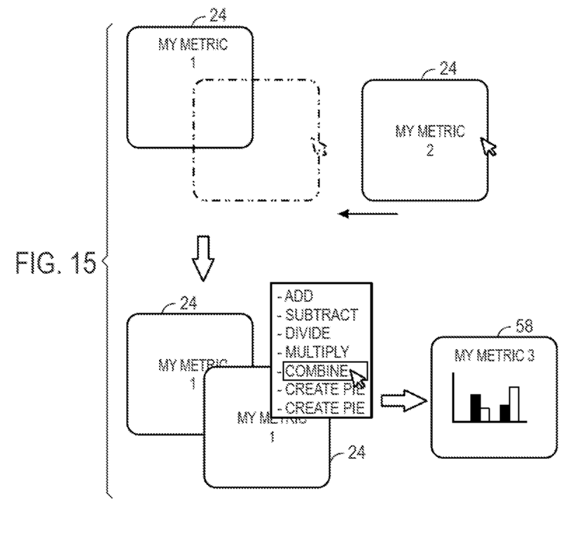

There may be a variety of ways for a user to organize the metric boxes 24 with the dashboard software 20. As mentioned above, a user may be able to resize the metric boxes 24 as desired, to draw attention to more important metrics. Additionally, a user may arrange multiple metric boxes into a widget 60, as illustrated in FIG. 15.

Any of the metric boxes 24 may be arranged to form a widget 60, such that the user has complete control over how metrics are grouped together. Information regarding individual widgets 60 may be stored in a widget data structure on the memory 14, similar to the metric data structure. The widget 60 may contain many of the features associated with an individual metric box 24, such as a title 28, a visualization icon 38, goals 44, overall value 46, a to-do list 50, a share icon 52, alerts 48, a download icon 54, and a resize icon 56, as illustrated in FIG. 15.

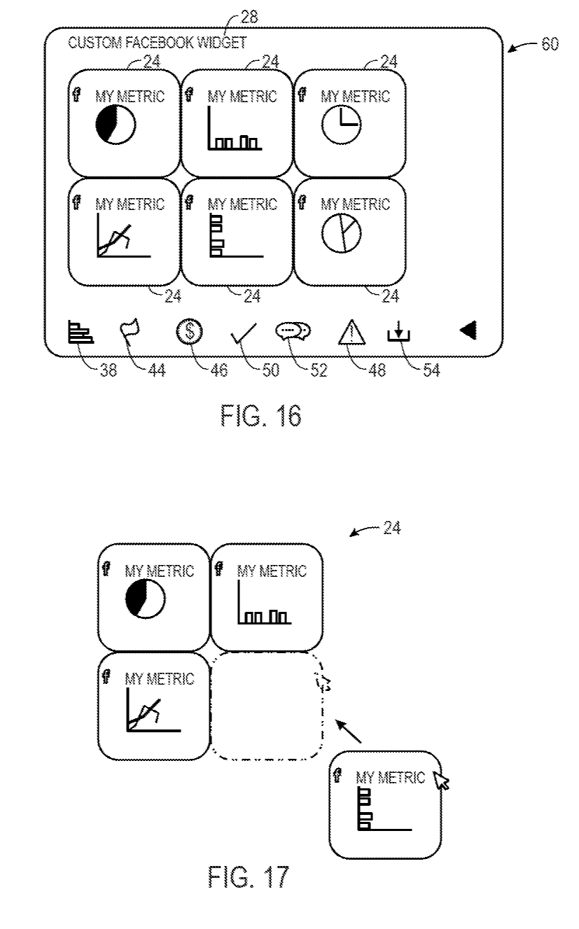

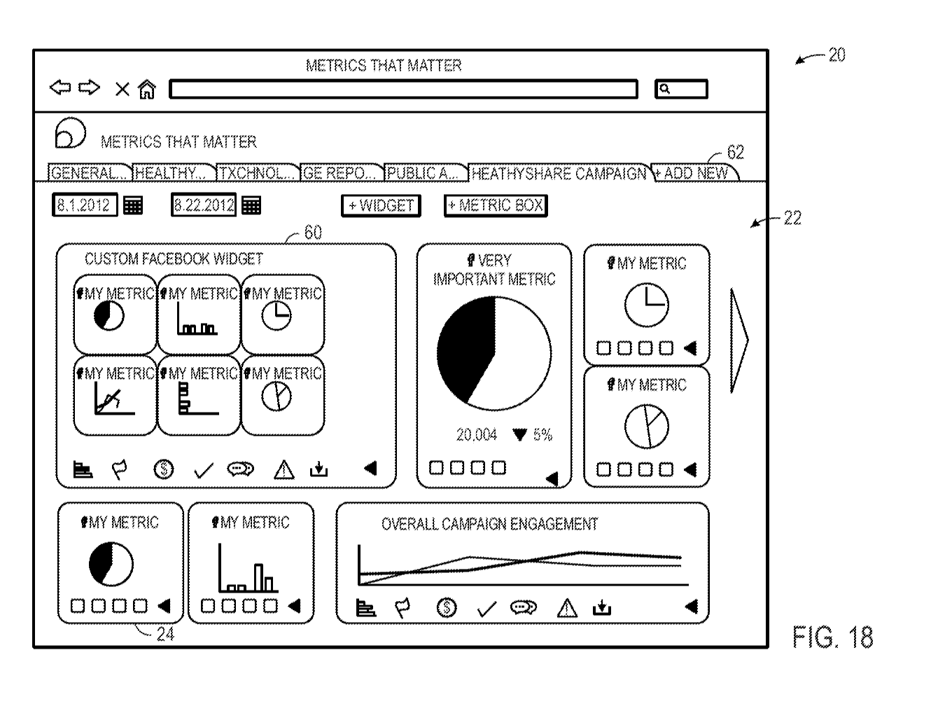

A widget 60 may be formed by “snapping” one or more metric boxes 24, as illustrated in FIG. 16. The “snapping” action may be dragging a metric box 24 near a side of another metric box or group of metric boxes until the two objects snap together to form a widget. As such, “snapping” may occur between one or more metric boxes and between widgets. Alternatively, dragging a metric box 24 over one or more other metric boxes may prompt a list of options, including the option to create a widget 60, as described above.

The dashboard software 20 may also contain multiple screens, such that metric boxes 24 and widgets 60 may be organized into the separate screens based on user preferences. For example, one screen may contain metric boxes and widgets relating only to social networking data, while another screen may contain metric boxes and widgets pertaining to the marketing and sales of a particular product. As shown in FIG. 17, the various screens may be accessible via tabs 62; alternatively, the user may select a screen via a drop-down menu.

One or more of the disclosed embodiments, alone or in combination, may provide one or more technical effects useful for user interaction structures in digital dashboard software. Certain embodiments may allow for increased user customization and organization within the dashboard software. For example, the present metric box user interface structure may allow the user to customize the metric box display for various metrics and to organize multiple metric boxes into widgets as they see fit. The present metric box user interface structure may also include a feature in which a user may “combine” two metric boxes such that the associated metrics serve as inputs to a data operation (e.g., addition, subtraction) whose result is displayed in a new metric box. Such a feature may allow users to actively manipulate metrics within the dashboard software. Still other embodiments may allow users to link various metrics to actions and decisions that result from the metrics. For example, the present metric box user interface may allow the user to assign overall values, goals, and to-do lists to a particular metric. The technical effects and technical problems in the specification are exemplary and not limiting. It should be noted that the embodiments described in the specification may have other technical effects and can solve other technical problems.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A non-transitory computer-readable medium storing computer executable code comprising instructions to:
run a digital dashboard application comprising:
a visualization data structure comprising visualizations;
a metric data structure comprising metrics; and
a metric box interface comprising one or more metric boxes, wherein a metric box is configured to display a primary set of metadata associated with a metric in the metric data structure, wherein the primary set of metadata comprises a visualization in the visualization data structure; and wherein two or more metric boxes may be combined, wherein the metrics displayed in the metric boxes serve as inputs in a data manipulation operation and the output of the data manipulation operation is displayed in an additional metric box.

2. The non-transitory computer-readable medium of claim 1, wherein the primary set of metadata comprises a graphic icon, a title, a time range value, a numeric value associated with the most recent value of the metric, and a numeric value associated with the change in value over the time range value.

3. The non-transitory computer-readable medium of claim 2, wherein each of the graphic icon, label or title, time range value, and visualization within the metric box are selectable for editing.

4. The non-transitory computer-readable medium of claim 1, wherein the metric box comprises a secondary set of metadata associated with the metric.

5. The non-transitory computer-readable medium of claim 4, wherein the secondary set of metadata comprises one or more colors assigned to a numeric value, a text description of the associated metric, goals associated with the metric, an overall value of the associated metric, alerts associated with the metric, and a to-do list associated with the metric.

6. The non-transitory computer-readable medium of claim 5, wherein the to-do list comprises items which may be assigned to a user.

7. The non-transitory computer-readable medium of claim 6, wherein the digital dashboard software is configured to send a notification to the user assigned an item on the to-do list.

8. The non-transitory computer-readable medium of claim 5, wherein the to-do list is exportable to a separate application stored on a non-transitory computer-readable medium.

9. The non-transitory computer-readable medium of claim 1, wherein the metric box is configured to be shared with another user.

10. The non-transitory computer-readable medium of claim 9, wherein the metric box is configured to be shared with another user outside of the digital dashboard software.

11. The non-transitory computer-readable medium of claim 1, wherein archived data associated with the metric displayed in the metric box may be downloaded.

12. The non-transitory computer-readable medium of claim 1, wherein the data manipulation operation comprises addition, subtraction, multiplication, division, and averaging operations.

13. The non-transitory computer-readable medium of claim 1, wherein the data manipulation operation comprises creating a data comparison visualization.

14. The non-transitory computer-readable medium of claim 1, wherein two or more metric boxes may be arranged to form a widget.

15. The non-transitory computer-readable medium of claim 1, wherein the digital dashboard application comprises one or more screens and wherein the metric boxes are separated into the one or more screens.

16. A system comprising:
a memory;
a display;
a user input device; and
a processor, wherein the processor is configured to control a digital dashboard software comprising:
a visualization data structure comprising visualizations;
a metric data structure comprising metrics; and a metric box interface comprising one or more metric boxes, wherein a metric box is configured to display a primary set of metadata associated with a metric in the metric data structure, wherein the primary set of metadata comprises a visualization in the visualization data structure; and wherein two or more metric boxes may be combined, wherein the metrics displayed in the metric boxes serve as inputs in a data manipulation operation and the output of the data manipulation operation is displayed in an additional metric box.

17. The system of claim 16, wherein the digital dashboard software comprises a sync function.

18. The system of claim 16, wherein the primary set of metadata comprises a graphic icon, a title, a time range value, a numeric value associated with the most recent value of the metric, and a numeric value associated with the change in value over the time range value.

19. The system of claim 16, wherein the metric box comprises a secondary set of metadata associated with the metric.

20. The system of claim 19, wherein the secondary set of metadata comprises one or more colors assigned to a numeric value, a text description of the associated metric, goals associated with the metric, an overall value of the associated metric, alerts associated with the metric, and a to-do list associated with the metric.

21. A method comprising:
storing a visualization in a visualization data structure in a memory;
storing a metric in a metric data structure in the memory;
displaying a metric box comprising a metric stored in the metric data structure using a visualization stored in the visualization data structure;
manipulating data associated with two or more metric boxes in response to user input; and
organizing metric boxes in response to user input.

22. The method of claim 21, wherein manipulating data comprises combining two or more metric boxes such that the metric displayed in the metric boxes serve as inputs in a data manipulation operation and the output is displayed in an additional metric box.

23. The method of claim 21, wherein organizing metric boxes comprises arranging two or more metric boxes to form a widget.

24. The method of claim 21, wherein organizing metric boxes comprises separating metric boxes onto one or more screens.
